(19) United States
(12) Patent Application Publication
(10) Pub. No.: US 2013/0174585 A1
(43) Pub. Date: Jul. 11, 2013

(54) METHOD AND DEVICE FOR STORING A CRYOGENIC FLUID AND WHICH ARE SUITABLE FOR SOILS INCLUDING PERMAFROST

(71) Applicant: Pascal Collet, Paris La Defense (FR)

(72) Inventor: Pascal Collet, Paris La Defense (FR)

(73) Assignee: TOTAL SA, Courbevoie (FR)

(21) Appl. No.: 13/825,745

(22) PCT Filed: Aug. 19, 2011
(86) PCT No.: PCT/FR11/51937

§ 371 Date: Mar. 22, 2013

(30) Foreign Application Priority Data
Sep. 22, 2010 (FR) 10 57626

(51) Int. Cl. F17C 3/00

(52) U.S. Cl. CPC F17C 3/005
USPC 62/53.1

(57) ABSTRACT

The invention relates to a method for storing a cryogenic fluid, implementing a tank including at least one vessel capable of containing the cryogenic fluid. The method including the following steps: a) placing the tank on, in, or partially in soil including permafrost; b) feeding the cryogenic fluid into the vessel; and c) exchanging heat between the cryogenic fluid and the soil, in order to freeze and/or keep a portion of the soil frozen, such that said portion of the soil can be used as the foundation for the tank.

### RELATED APPLICATIONS

The present application is a National Phase entry of PCT Application No. PCT/FR2011/051937, filed Aug. 19, 2011, which claims priority from FR Application No. 10 57626, filed Sep. 22, 2010, the disclosures of which are hereby incorporated by reference herein in their entirety.

### FIELD OF THE INVENTION

The present invention relates to a method and a device for storing a cryogenic fluid which are suited to grounds comprising permafrost.

### BACKGROUND OF THE INVENTION

The fluids in question are produced by techniques involving cryogenics and are typically at temperatures below −150° C. (123 K). By way of example, mention may be made of liquefied natural gas, or LNG, at around −161° C., or even liquid nitrogen and liquid oxygen.

In order to store such fluids, it is known practice to use tanks comprising at least one vessel suited to low temperatures and to surround this vessel with highly effective insulating means in order to minimize heat losses between the fluid and the external environment. In general, these means can be likened to a steel or concrete shell surrounding the vessel and containing highly insulating materials such as perlite. Furthermore, in order to prevent the ground from freezing, heating means such as resistive electric elements are sometimes fitted beneath the tank. These insulation requirements apply not only to tanks built at the surface, but also those created in the rock.

Given their structure and dimensions, the tanks are very heavy and, depending on the mechanical quality of the ground, it is often necessary to create foundations which are costly in terms of financial investment and also in terms of construction time. Further, these foundations leave traces in the environment or make the tanks difficult to dismantle.

In areas such as the polar or subpolar regions, constructing tanks posses problems for at least two reasons: firstly, because of the particularly harsh weather conditions and secondly, because of the instability of the ground due notably to the presence in the ground of permafrost either at the surface or at a certain depth. Permafrost is ground or part of the ground which is naturally frozen for at least two years. In fact, the ground undergoes partial freezing/thawing cycles due to seasonal changes to the weather. The extent of the regions of ground affected by permafrost also varies with changes to the climate. The boundary between frozen ground and non-frozen ground therefore changes as a function of complex climatic and environmental parameters.

### SUMMARY OF THE INVENTION

It is an object of the present invention to address all or some of the abovementioned disadvantages, namely in particular to provide a method for storing a cryogenic fluid in a region where the ground comprises permafrost, which notably make it possible to reduce the construction cost and/or time and the impact the construction has on the environment.

The solution covered by the invention relates to a method for storing a cryogenic fluid, using a tank comprising at least one vessel able to contain the cryogenic fluid, the method comprising the following steps:
a) installing the tank on, in or partially in a ground comprising permafrost;
b) injecting cryogenic fluid into the vessel; and
c) exchange of heat between the cryogenic fluid and the ground so as to freeze a portion of the ground and/or keep it frozen, so that said portion of the ground acts as foundations for the tank.

In step a) “installing” means that the tank is either built in situ, or alternatively built elsewhere and brought to site, or alternatively still, that it is partially prefabricated, then assembled in situ. It may be placed on the ground. It may be fully buried in the ground. It may be partially buried.

The ground in question comprises permafrost at its surface and/or deeper down. The exchange of heat mentioned in step c) takes place between a fluid at a temperature of −150° C. or below and the ground surrounding the tank. According to one particular embodiment, it takes place directly across the walls of the tank and any slab that may form part of the modified ground.

According to another embodiment, suitable means are used to circulate the cryogenic fluid into the ground. According to another embodiment, exchange takes place indirectly via a fluid which exchanges both with the cryogenic fluid and with the ground.

The (relative) warmth of the ground is transmitted to the cryogenic fluid, which is the same as saying that the cryogenic fluid surrenders cold to the ground. This cooling of the ground allows it to be frozen or kept frozen over a region of given extent. The portion of ground that is frozen is not necessarily in contact with the tank, but is subject to the loadings applied to the ground by the tank. This has the effect of stabilizing the ground near the tank, preventing it from thawing. This has the advantage of mitigating the seasonal effects of the weather (freezing/thawing) or even still of mitigating the effects of change in the climate in the direction of a warming up which would cause the permafrost to retreat. Deformations of the ground over the course of time, whether caused naturally or by the tank, are lessened.

The ground thus stabilized serves as natural foundations of the tank. Knowing the rheology of the ground, it is possible to determine the extent of the frozen region that needs to be obtained or maintained in order to secure this effect. In theory, a minimal extent is aimed for, with a margin for safety, because this exchange of heat costs energy taken from the cryogenic fluid.

One parameter to be taken into consideration is the potential presence of support elements lightening the tank. In this case, the frozen region collaborates with these elements in order mechanically to support the tank, without experiencing excessive deformation.

According to a preferred embodiment, there are no support elements reducing the load applied by the tank to the ground.

According to some particular embodiments, the invention may implement one or more of the following features:

said cryogenic fluid is liquefied natural gas (LNG).

said ground is a seabed and, in step a), the tank is floated out then submerged by filling one or more ballast tanks These ballast tanks may be temporary or permanent. What is meant by “temporary” is that they do not form part of the tank as installed on its site.

in step c), with said portion of ground kept frozen having a given extent and with said exchange of heat having a given power, this power is adjusted so as to control the extent of said portion of ground.

with the vessel able to contain the cryogenic fluid surrounded by a shell, a first part of said shell is insulating and the exchange of heat of step c) comprises thermal conduction across a second part of said shell, said second part being in contact with said portion of ground.

in step c), with said second part of the shell having given thermal conduction properties and with said thermal conduction across a second part of said shell occurring at a given conduction power, said second part of the shell is modified so as to improve or degrade the conduction properties in order to control said conduction power.

in step a), prior to the placement of the tank on the ground, the ground is flattened and provided with a bedding layer able to accept the tank.

prior to the installation of the tank on the ground which is performed in step a), a cryogenic fluid is injected into the ground so as to freeze said portion of ground or keep it frozen so that said portion of ground is able mechanically to support the tank.

Fully or partially submerging the tank and placing it on a seabed offers the advantage that it can be constructed elsewhere and brought onto site for example by floating it out. Further, after it has been dismantled, it will leave no traces on shore; at the very most, the seabed will have been modified a little.

The choice between an on-shore tank or an off-shore tank is connected with constraints relating to legislation, accessibility or even feasibility of on-shore construction. The invention makes it possible to plan installation on the seabed by reducing the weight, the volume of the installations and thus reducing the impact on the seabed. It is thus possible to obtain installations that last for longer, irrespective of how the permafrost in the seabed changes.

The invention is particularly well suited to a seabed containing permafrost. This is because the seasonal and long-term changes to the seabed are less well known and more difficult to predict than changes in the ground on land. Marine permafrost is often of fossil origin, with a barrier effect due to the sea, but is also influenced by variations in salinity, current, etc. It is even more advantageous to be able to stabilize such ground.

Further, the heat taken out of the ground that is to be frozen or kept frozen can be adjusted, so as to control the extent of the bearing region. This makes it possible to minimize energy expenditure by aiming for a region of minimal extent, while still maintaining a margin for safety which is of the same order of magnitude as is used for conventional foundations.

One particular way of allowing the exchange of heat in step c) is to plan for thermal conduction across part of the shell of the tank, the other part being insulating. Quite clearly, these ideas of insulation and conduction are to be interpreted in a relative sense. Given the temperature of the cryogenic fluid, it is possible to choose the tank shell materials and thickness in such a way as to achieve the desired heat transfer coefficient (in W/m²/K) in conjunction with the desired extent of the frozen region.

In particular, it is possible to control the specific conduction power (in W/m²) by altering the level of fill or composition of a shell made up of a double wall. It is also possible to provide modifiable heat-conducting bridges between these two walls.

Thus, according to another embodiment of the invention, part of the shell of the tank comprises a double wall, and the conduction properties are improved or degraded

either by modifying the degree to which the double wall is filled with a liquid;

or by modifying the composition of a liquid contained in the double wall;

or by creating modifiable heat-conducting bridges between these two walls.

Before the tank is placed or constructed, the ground, onshore or offshore, may have been modified. It may have been flattened and provided with a bedding layer or a slab to accept the tank. By convention, throughout this application, these modifications to the ground, if present, will be considered to form part of the ground rather than the tank. Thus, the tank is in contact with the natural or modified ground.

In order to prepare ground that might not be suitable, a cryogenic fluid may be injected prior to the installation of the tank in step a). This fluid may be a different fluid from that stored. For example, it may be liquid nitrogen. This injection may continue beyond step a). It may be concomitant with step c) or alternatively may cease at a given moment. It has the advantage of preconditioning the ground before the tank is in place or before the cooling performed using the cryogenic fluid stored in the tank has had its effect.

The invention also relates to an installation for storing a cryogenic fluid comprising:

a tank provided with a vessel containing a cryogenic fluid, the tank resting on or being completely or partially buried in a ground comprising permafrost; and

a portion of the ground which is frozen or kept frozen by exchange of heat with the cryogenic fluid, such that said portion of the ground serves as foundations for the tank.

The portion of ground that is frozen may be the only foundations the tank has or may supplement conventional foundations.

According to some particular embodiments, the invention may implement one or more of the following features:

the cryogenic fluid is LNG.

the tank comprises one or more ballast tanks that can be filled with water, and it is partially or completely submerged, said ground comprising permafrost being a seabed.

the tank further comprises a shell surrounding said vessel, said shell comprising a thermally insulating first part and a second part that has an internal surface on the vessel side and an external surface in contact with said portion of ground, said second part being a conductor of heat so that at least some of said exchange of heat is by thermal conduction across said second part of the shell.

with said second part of the shell having a given composition, and with said internal and external surfaces each having a given extent, the second part of the shell is designed in such a way that:
said composition can be modified selectively so as selectively to increase or decrease said thermal conduction across the second part of the shell; and/or
said extent can be selectively adjusted so as selectively to increase or decrease said thermal conduction across the second part of the shell.

with said shell comprising a portion in contact with the ground, said second part consists of said portion of the shell.

The reservoir may have ballast tanks Depending on the degree to which they are filled with seawater, they modify the mass of the tank and allow it to be sunk or raised, notably so as to be able to float it out to the desired location.

If the tank is brought to site by floating it out, the constraints regarding buoyancy and stability during the transport phase need to be taken into consideration. The issue is notably one of minimizing the impacts on the stability of the tank on its definitive site, placed on or in the ground, subjected to upthrust (in the case of empty tanks), lateral thrust from the waves, tides and ice, the loads associated with mooring and ships coming alongside, etc. To achieve that, definitive and/or temporary ballast tanks may be installed in or on the outside of the build.

The tank needs to be sized to take account of all the phases of the project (cf. for example, Eurocode 0 which collates the standards covering the basis of structural design) and conditions covering personal safety and respect for the environment.

The shell surrounding the vessel or vessels of cryogenic fluid comprises a conventional insulating part, generally in the upper part of the tank. It may also comprise another part that is less insulating, or even rather conducting of heat, generally situated in the lower part of the tank. This less insulating part is intended to be in contact with the ground. Thus, the heat transfer can be by conduction, through simple contact with the ground. This ground may have been modified and may comprise a slab, in which case conduction will naturally be through the slab.

In order to control the extent of the frozen portion of ground, which is connected with the degree of heat transfer, it is possible to modify the properties of the second part of the shell. For example, its internal composition may be changed, filling it to a greater or lesser extent, or using materials of different conductivity. It is also possible to create or eliminate heat-conducting bridges. It is even possible to increase or decrease the external surface area of the second part.

According to one particular embodiment, the relatively conducting second part of the shell is the part in contact with the ground. The relatively insulating first part is generally in contact with the sea or with the atmosphere or even with structures that may be on the tank, for example a liquefaction and compression unit, workshops, a control room or living quarters for those operating the installation or visitors.

If the tank is installed on a seabed, it is possible as an alternative to use a shell of which the more conducting second part is in contact not only with the ground but also with the sea. A layer of ice then forms around the tank and increases its footprint, and this may contribute to stabilizing it.

One embodiment, suited to the offshore scenario, is that of constructing a tank the lateral walls of which are of the double-hull design with a single-hull bottom.

The installation may comprise a device for monitoring the temperature gradient between the ground and the bottom of the tank. It may for example comprise thermocouples arranged under the tank at suitable locations making it possible to determine the extent of the portion of ground that is frozen.

### BRIEF DESCRIPTION OF THE FIGURES

Other specifics and advantages of the present invention will become apparent from the following description of some nonlimiting embodiments, with reference to the attached drawings in which:

FIG. 1 depicts a schematic view in vertical section for a site for which the invention is particularly well suited;

Figure depicts a prior modification to the ground according to the invention;

Figure depicts thermal conditioning of the ground according to the invention;

FIGS. 4 and 5 show the construction and one method of installing the tank according to one embodiment of the invention;

FIG. 6 illustrates an example of a tank according to the invention, in situ.

For the sake of clarity, the various elements depicted in these figures are not necessarily drawn to scale. In the figures, identical references correspond to elements that are identical.

### DETAILED DESCRIPTION OF THE FIGURES

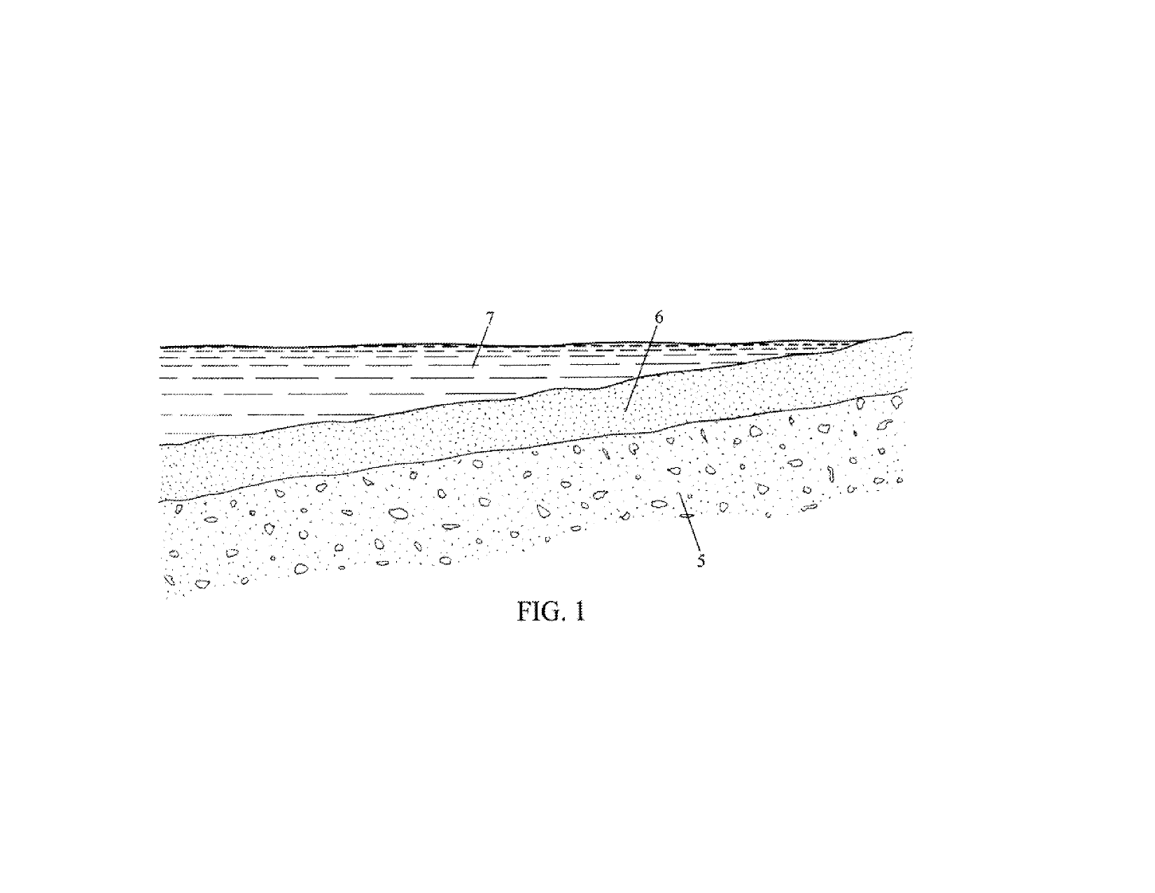

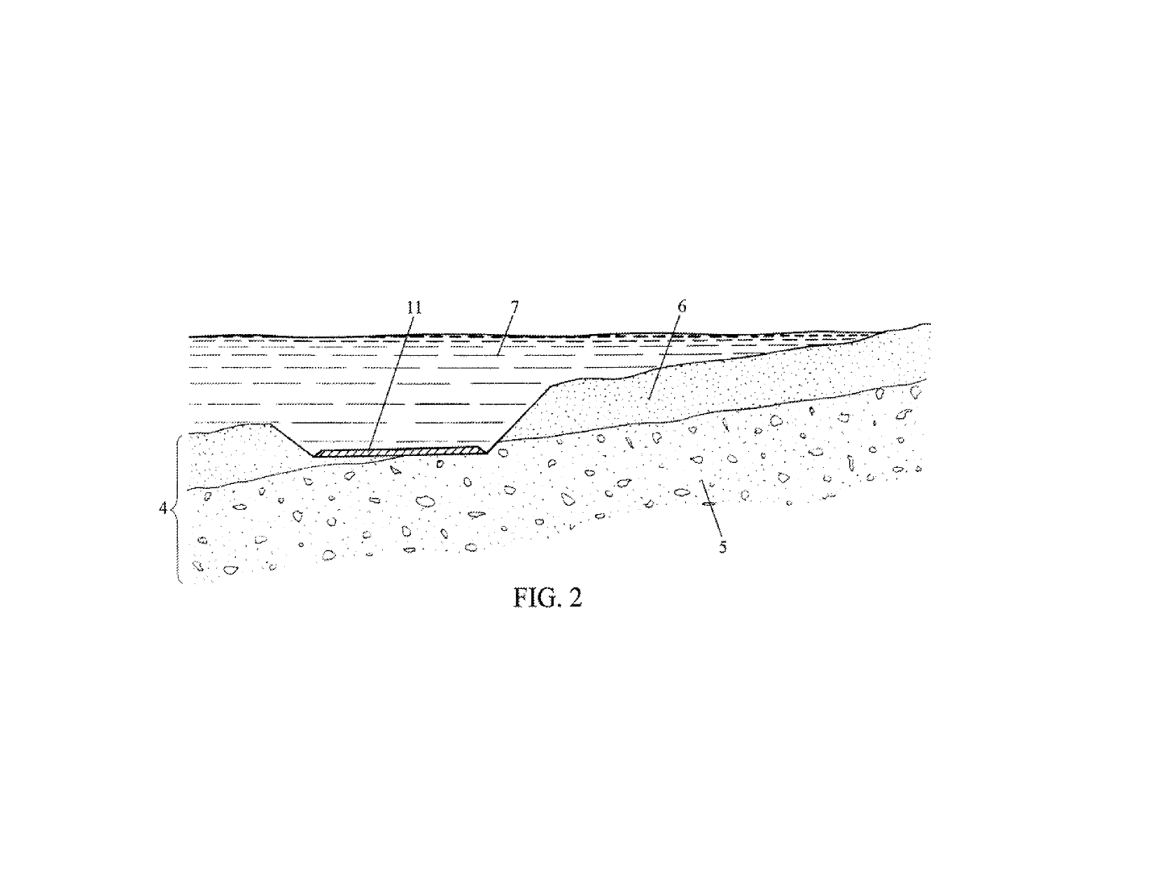

FIG. 1 is a simplified vertical section through a site, in the regions of the Arctic Circle, for which the invention is particularly well suited. The ground 4 is part of the continental shelf The sea 7 is not very deep. The ground comprises permafrost 5, often of fossil origin. It is surmounted by a layer 6 which is not permafrost, which means to say it does not remain frozen for two years in succession.

The section would be somewhat the same onshore, but without the sea. However, the presence of the sea 7 introduces an additional complicating factor by comparison with the on-shore scenario. This is because the temperature of the sea 7, its state (whether or not it has frozen), its salinity (which is sensitive to ice runs), the presence of pack ice and marine currents vary and may aggravate the instability of the ground 4.

FIG. 2 illustrates one possible modification to the ground 4, prior to the installation of an LNG tank. This modification here involves dredging which has removed part of the layer 6, leveled the seabed and possibly created an access channel (not depicted) so that ships can approach the tank. A horizontal slab 11 has been poured. It is intended to accept the tank. Once again, these modifications to the ground, if any, will be considered to form part of the ground 4, which may therefore be natural or artificial ground.

FIG. 3 shows conditioning of the ground 4 that involves injecting for example liquid nitrogen 12 directly into the ground 4 in order to obtain a portion of ground that is frozen. This conditioning prepares the ground 4 for the installation of the tank. This injection may continue after the tank has been commissioned.

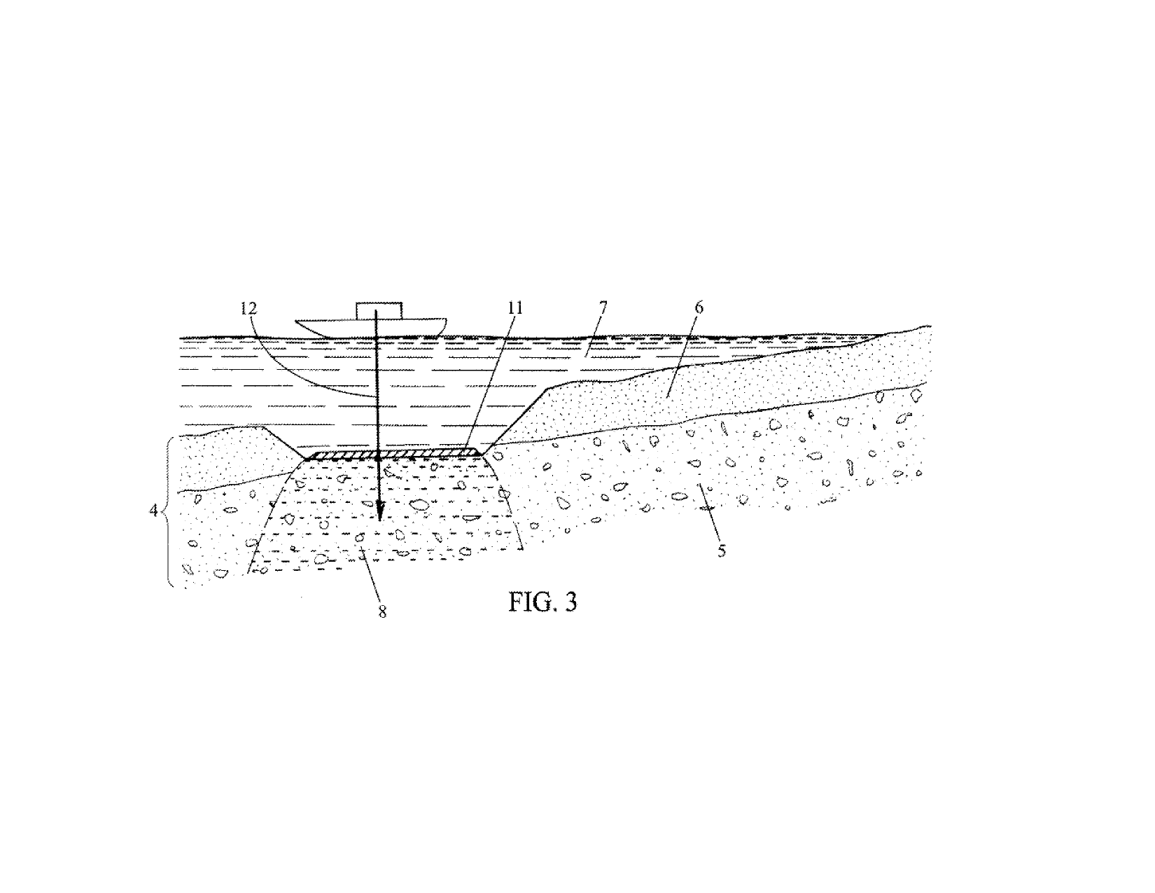

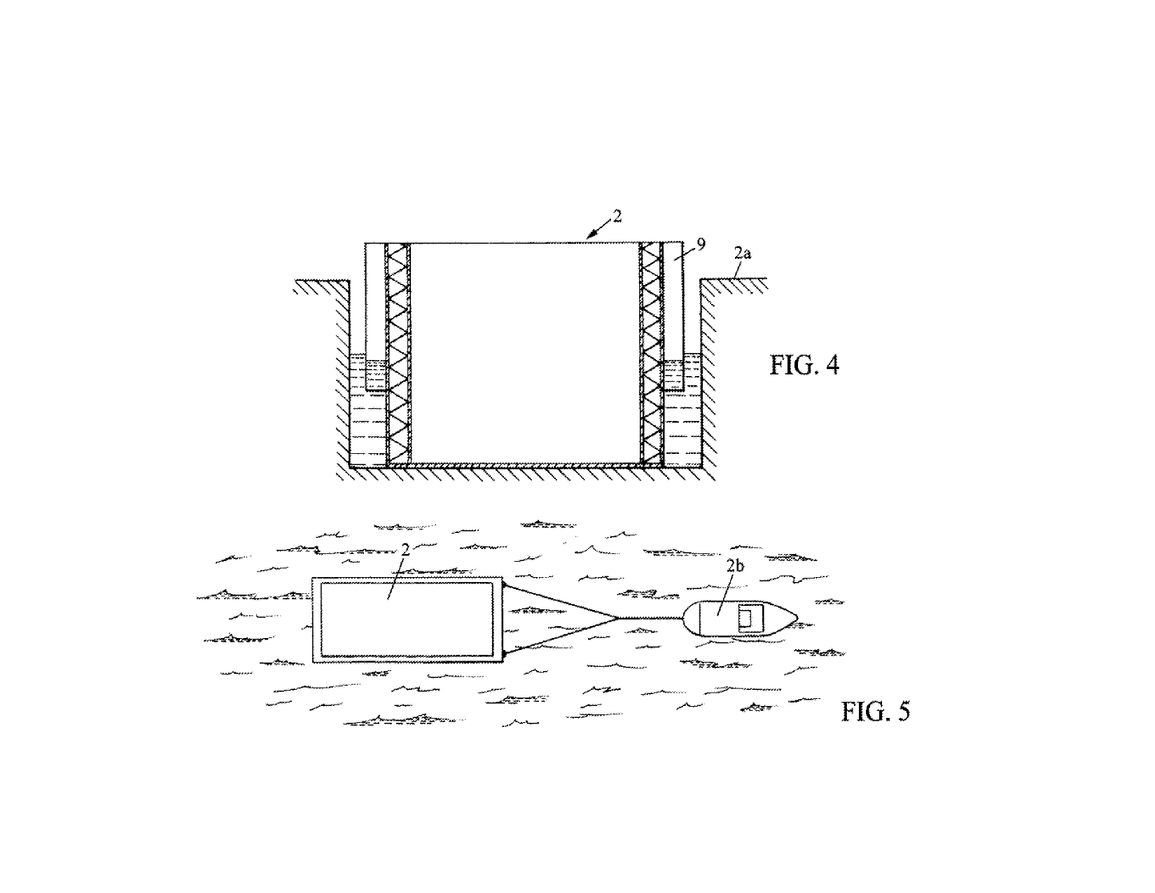

In FIG. 4, the tank 2 is assembled in a dry dock 2a situated some distance from the site on which the tank is to be installed. It is fitted with ballast tanks 9 so that it can be floated once the dock 2a has been flooded. As FIG. 5 shows, the tank 2, floating, is towed out by a ship 2b to the site. Next, the ballast tanks 9 are filled with seawater and the tank 2 is “sunk” at the location where it is to be installed. The tank may be made of any suitable material, chosen notably for its mechanical and/or thermal properties.

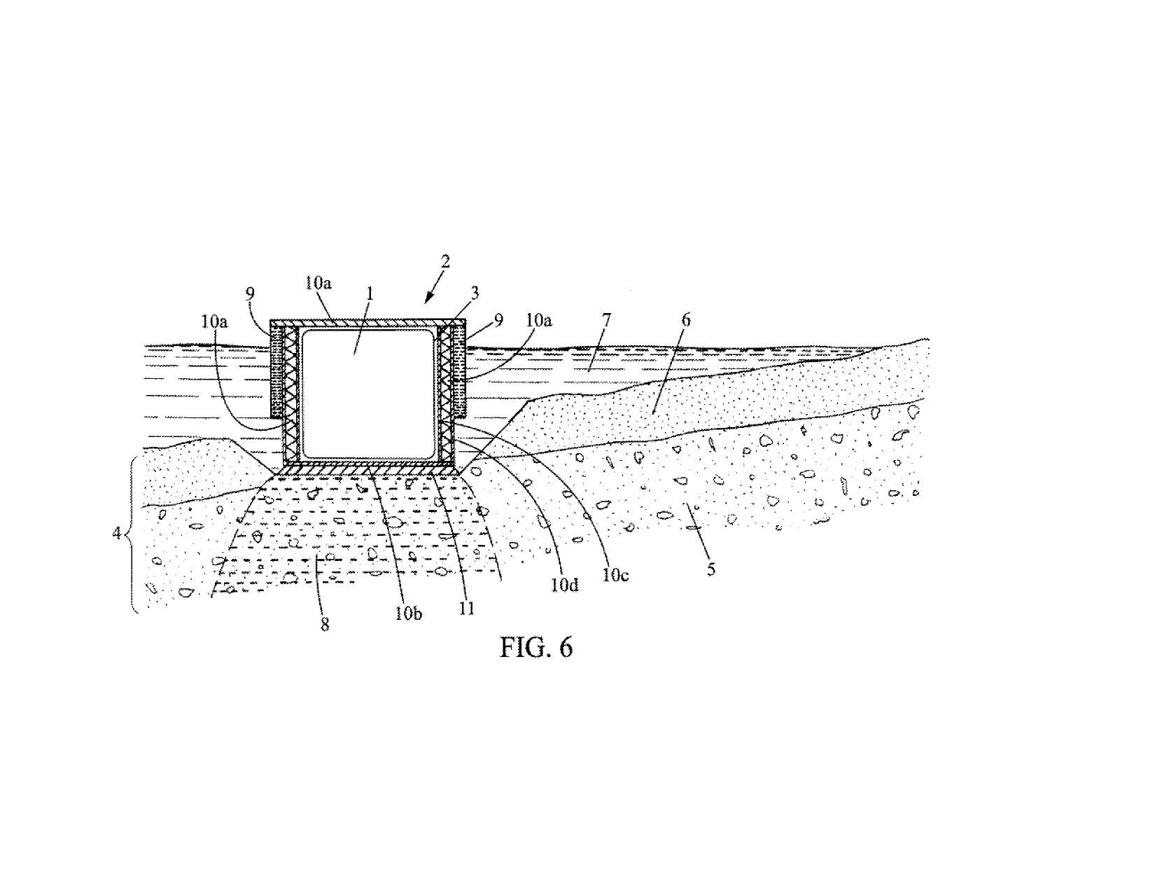

FIG. 6 shows the tank 2 in situ once it has been installed on the ground 4. The tank is partially out of the water and may comprise superstructures (not depicted), notably for liquefying, vaporizing and compressing the LNG. Any connections that might be between the tank 2 and the shore (pipelines, electrical cables) have not been depicted.

The LNG 1 is injected, after being liquefied, into at least one storage vessel 3. This vessel is surrounded by a shell made up of a thermally insulating first part 10a comprising insulating vertical double lateral walls and an insulating apron and of a second part 10b which is a better conductor of heat or is less insulating. This second part 10b is in contact with the ground 4, which may possibly comprise a supporting slab 11. The shell comprises an internal surface 10c on the vessel 3 side and an external surface 10d in contact notably with the ground 4, the sea 7 and the atmosphere.

The cold of the LNG 1 is imparted to the ground 4 by conduction through the second part 10b of the shell. A permanently frozen portion of ground 8 is thus formed. This constitutes “natural” foundations for the tank 2. The injection of liquid nitrogen 12 which is described in FIG. 3 may supply additional cooling, either temporarily, for example as long as conduction has not reached a steady state or alternatively at certain moments, or even permanently.

It is possible to alter the thermal properties (conductivity) of the second part 10b of the shell or vary the extent thereof, in order to alter the heat transfer.

The tank 2 may also comprise conventional foundations (not depicted), for example consisting of piles. The portion of frozen ground 8 then acts as additional foundations. It mechanically supports the tank 2 without, however, being subjected to all of the mechanical loading.

The embodiments above are intended to be illustrative and not limiting. Additional embodiments may be within the claims. Although the present invention has been described with reference to particular embodiments, workers skilled in the art will recognize that changes may be made in form and detail without departing from the spirit and scope of the invention.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1-15. (canceled)

16. A method for storing a cryogenic fluid, using a tank comprising at least one vessel able to contain the cryogenic fluid, the method comprising the following steps:
a) installing the tank on, in or partially in a ground comprising permafrost;
b) injecting the cryogenic fluid into the vessel; and
c) exchanging the heat between the cryogenic fluid and the ground so as to freeze a portion of the ground and/or keep it frozen, so that said portion of the ground acts as foundations for the tank;
and wherein said ground is a seabed and, in step a), the tank is floated out then submerged by filling one or more ballast tanks.

17. The storage method as claimed in claim 16, wherein said cryogenic fluid is liquefied natural gas.

18. The method as claimed in claim 16, wherein, in step c), with said portion of ground having a given extent and with said exchange of heat having a given power, this power is adjusted so as to control the extent of said portion of ground kept frozen.

19. The method as claimed in claim 16, wherein, the vessel is surrounded by a shell, a first part of said shell is insulating and the exchange of heat of step c) comprises thermal conduction across a second part of said shell, said second part being in contact with said portion of ground.

20. The method as claimed in claim 19, wherein, in step c), with said second part of the shell having given thermal conduction properties and with said thermal conduction across the second part of said shell occurring at a given conduction power, said second part of the shell is modified so as to improve or degrade the conduction properties in order to control said conduction power, once the tank has been installed.

21. The method as claimed in claim 20, wherein the second part of the shell comprises a double wall,
and in that the conduction properties are improved or degraded by modifying the degree to which the double wall is filled with a liquid.

22. The method as claimed in claim 20, wherein the second part of the shell comprises a double wall,
and in that the conduction properties are improved or degraded by modifying the composition of a liquid contained in the double wall.

23. The method as claimed in claim 20, wherein the second part of the shell comprises two walls,
and in that the conduction properties are improved or degraded by modifiable heat-conducting bridges between these two walls.

24. The method as claimed in claim 16, wherein, in step a), prior to the placement of the tank on the ground, the ground is flattened and provided with a bedding layer (11) able to accept the tank.

25. The method as claimed in claim 16, wherein, prior to the installation of the tank on the ground which is performed in step a), a cryogenic fluid is injected into the ground so as to freeze said portion of ground or keep it frozen so that said portion of ground is able mechanically to support the tank.

26. An installation for storing a cryogenic fluid comprising:
a tank provided with a vessel containing a cryogenic fluid, the tank resting on or being completely or partially buried in a ground comprising permafrost; and
a portion of the ground which is frozen or kept frozen by exchange of heat with the cryogenic fluid, such that said portion of the ground serves as foundations for the tank; wherein the tank comprises one or more ballast tanks that can be filled with water, and in that it is partially or completely submerged, said ground comprising permafrost being a seabed.

27. The storage installation as claimed in claim 26, wherein the cryogenic fluid is LNG.

28. The storage installation as claimed in claim 26, wherein the tank further comprises a shell surrounding said vessel, said shell comprising a thermally insulating first part and a second part that has an internal surface on the vessel side and an external surface in contact with said portion of ground, said second part being a conductor of heat so that at least some of said exchange of heat is by thermal conduction across said second part of the shell.

29. The storage installation as claimed in claim 28, wherein, with said second part of the shell having a given composition, and with said internal and external surfaces each having a given extent, the second part of the shell is designed in such a way that:
said composition can be modified selectively so as selectively to increase or decrease said thermal conduction across the second part of the shell; and/or
said extent can be selectively adjusted so as selectively to increase or decrease said thermal conduction across the second part of the shell.

30. The storage installation as claimed in claim 28, wherein, with said shell comprising a portion in contact with the ground, said second part consists of said portion of the shell.
